(19) United States
(12) Patent Application Publication
(10) Pub. No.: US 2021/0268430 A1
(43) Pub. Date: Sep. 2, 2021

(54) SELECTIVELY PERMEABLE GRAPHENE OXIDE MEMBRANE FOR DEHYDRATION OF A GAS

(71) Applicant: NITTO DENKO CORPORATION, Osaka (JP)

(72) Inventors: Shijun Zheng, San Diego, CA (US); Weiping Lin, Carlsbad, CA (US); Peng Wang, San Diego, CA (US); Isamu Kitahara, San Diego, CA (US); Bita Bagge, Vista, CA (US); John Ericson, Poway, CA (US)

(21) Appl. No.: 17/254,765

(22) PCT Filed: Jun. 20, 2019
(86) PCT No.: PCT/US2019/038224

§ 371 Date: Dec. 21, 2020

Related U.S. Application Data
(60) Provisional application No. 62/688,318, filed on Jun. 21, 2018.

(51) Int. Cl. B01D 53/22; B01D 53/26; B01D 69/14; B01D 71/02; B01D 71/40; B01D 71/38; B01D 69/02; B01D 67/00; B01D 69/10

(52) U.S. Cl. CPC B01D 53/228; B01D 53/268; B01D 69/148; B01D 71/024; B01D 71/40; B01D 2323/30; B01D 69/02; B01D 67/0079; B01D 69/105; B01D 2325/04; B01D 71/38

(57) ABSTRACT

Described herein is a graphene oxide and polymer based selectively permeable element that provides selective gas, and vapor resistance for dehumidification applications. The graphene oxide is cross-linked with polyvinyl alcohol, the polymer comprises an ammonium salt polymer such as poly(diallyldimethylammonium) chloride. Also described is a selectively permeable element where the graphene may be selected from reduced graphene oxide, graphene oxide, and is also functionalized or crosslinked. Also described is a selectively permeable element where there is crosslinking between the graphene and/or the polymers to provide enhanced gas resistance with water vapor permeability. A selectively permeable device is also described that incorporates the selectively permeable element and further comprises a substrate and a protective coating, encompassing the selectively permeable element. Also described are methods for making the aforementioned selectively permeable elements and related devices.

### CROSS REFERENCE TO RELATED APPLICATIONS

This application claims the benefit of U.S. Provisional Application No. 62/688,318, filed Jun. 21, 2018, which is incorporated by reference in its entirety.

### FIELD

The present embodiments are related to polymeric membranes, including membranes comprising graphene materials for applications such as removing water or water vapor from air or other gas streams and energy recovery ventilation (ERV).

### BACKGROUND

The presence of a high moisture level in the air may make people uncomfortable, and also may cause serious health issues by promoting growth of mold, fungus, as well as dust mites. In manufacturing and storage facilities, high humidity environments may accelerate product degradation, powder agglomeration, seed germination, corrosion, and other undesired effects, which is a concern in chemical, pharmaceutical, food and electronic industries. One of the conventional methods to dehydrate air includes passing wet air through hydroscopic agents, such as glycol, silica gel, molecular sieves, calcium chloride, and phosphorus pentoxide. This method has many disadvantages: for example, the drying agent has to be carried over in dry air stream; and the drying agent also requires replacement or regeneration over time, which makes the dehydration process costly and time consuming. Another conventional method of dehydration of air is a cryogenic method involving compressing and cooling the wet air to condense moisture, however, this method is highly energy consuming.

Compared with traditional dehydration or dehumidification technologies described above, membrane-based gas dehumidification technology has distinct technical and economic advantages. The advantages include low installation investment, easy operation, high energy efficiency, low process cost, and high processing capacity. This technology has been successfully applied in dehydration of nitrogen, oxygen and compressed air. For energy recovery ventilator (ERV) applications, such as inside buildings, it is desirable to provide fresh air from outside. Energy is required to cool and dehumidify the fresh air, especially in hot and humid climates, where the outside air is much hotter and has more moisture than the air inside the building. The amount of energy required for heating and cooling can be reduced by transferring heat and moisture between the exhausting air and incoming fresh air through an ERV system. The ERV system comprises a membrane which separates exhausting air and incoming air physically, but allows the heat and moisture exchange. The required key characteristics of the ERV membrane include: (1) low permeability of air and gases other than water vapor; (2) high permeability of water vapor for effective transfer of moisture between the incoming and the outgoing air stream while blocking the passage of other gases; and (3) high thermal conductivity for effective heat transfer.

There is a need for membranes with high permeability of water vapor and low permeability of air for ERV applications.

### SUMMARY

The present disclosure relates to gas separation membranes where a high moisture permeability and a low gas permeability may be useful to effect dehydration of a gas. Described herein are membrane elements comprising a graphene oxide (GO) composite which may reduce water swelling, and increase selectivity of water vapor/air permeability. Some embodiments further comprise an ammonium salt polymer, which may provide improved dehydration membranes relative to traditional polymer, e.g., PVA, membranes. The present embodiments include a selectively permeable element that is useful in applications where it is desirable to have limited gas permeability while concurrently enabling fluid or water vapor passage therethrough. Methods for efficiently and economically making these GO membrane elements are also described. Water can be used as a solvent in the preparation of these elements, making the process more environmentally friendly and more cost effective.

Some embodiments include a dehydration membrane comprising a support and a composite comprising a graphene oxide compound and an ammonium salt polymer. In some embodiments, the ammonium salt polymer comprises poly(diallyldimethylammonium) chloride. In some embodiments, the composite can coat the support. In some embodiments the membrane can have a high moisture permeability and low gas permeability. In some embodiments, the membrane can be dehydrating. In some embodiments, the membrane can selectively pass water vapor. In some embodiments, the membrane is relatively impermeable to a gas, e.g., air. In some embodiments, the support is porous. In some embodiments, the membrane can further comprise polyvinyl alcohol (PVA). In some embodiments, the graphene oxide compound and polyvinyl alcohol can be crosslinked. In some embodiments, the graphene oxide compound is selected from graphene oxide, reduced-graphene oxide, functionalized graphene oxide, and functionalized reduced-graphene oxide. In some embodiments, the composite can further comprise lithium chloride.

In some embodiments, the composite can further comprise calcium chloride. In some embodiments, the composite can further comprise a surfactant. In some embodiments, the surfactant can be sodium lauryl sulfate.

Some embodiments include a method for making a moisture permeable and/or gas barrier element. The method can comprise mixing a polymer solution, a graphene solution, and a cross linker solution to create an aqueous mixture; coating the mixture on a substrate to create a thin film of between about 1 μm to about 200 μm; drying the mixture for about 15 minutes to about 72 hours at a temperature ranging from 20° C. to about 120° C.; and annealing the resulting coating for about 10 hours to about 72 hours at a temperature ranging from about 40° C. to about 200° C. In some embodiments, the method can comprise mixing a polymer solution, a graphene solution, a cross linker solution, and an alkali halide or alkaline earth halide to create an aqueous mixture. In some examples, the element further comprises a protective coating.

Some embodiments include a method for dehydrating a gas comprising introducing a gas to a membrane described herein wherein water vapor permeates the membrane while the gas does not permeate the membrane.

These and other embodiments are described in greater detail below.

### BRIEF DESCRIPTION OF THE DRAWINGS

FIG. 1 is a possible embodiment of a nanocomposite membrane device that may be used in separation/dehydration applications.

FIG. 2 is one possible embodiment for the process for making a separation/dehydration element and/or device.

### DETAILED DESCRIPTION

A selectively permeable membrane includes a membrane that is relatively permeable to one material and relatively impermeable to another material. For example, a membrane may be relatively permeable to water vapor and relatively impermeable to gases such as oxygen and/or nitrogen. The ratio of permeability for different materials may be useful in describing their selective permeability.

The present disclosure relates to gas separation membranes where a high moisture permeability and a low gas permeability may be useful to effect dehydration of a gas. This membrane material may be suitable in the dehumidification of air, oxygen, nitrogen, hydrogen, methane, propylene, carbon dioxide, natural gas, methanol, ethanol, and/or isopropanol. In some embodiments, a membrane including a moisture permeable GO-ammonium salt polymer membrane composition may have a high H₂O/air selectivity. These embodiments may improve the energy efficiency of a dehydration membrane and/or an ERV system, as well as improve separation efficiency.

### Dehydration Membrane

Described herein are membranes comprising a highly selective hydrophilic GO-based composite material with high water vapor permeability, low gas permeability, and high mechanical and chemical stability. These membranes may be useful in applications where a dry gas or a gas with low water vapor content is desired.

In some embodiments, the membrane may be a dehydration membrane. In some embodiments, the membrane may be an air dehydration membrane. In some embodiments, the membrane may be a gas separation membrane. In some embodiments, a moisture permeable-and/or-gas impermeable barrier element containing a graphene material, e.g., graphene oxide, may provide desired selective gas, fluids, and/or vapor permeability resistance. In some embodiments, the selectively permeable element may comprise multiple layers, where at least one layer is a layer containing graphene material.

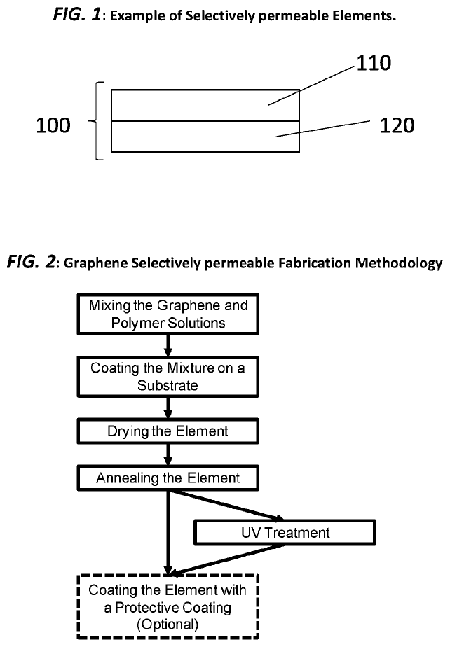

Generally, a dehydration membrane comprises a porous support and a composite coated onto the support. For example, as depicted in FIG. 1, selectively permeable device 100 comprises at least porous support 120, and a composite 110, comprising a graphene compound and a polymer. As a result of the layers, the selectively permeable device may provide a durable dehydration system that is selectively permeable to water vapor, and less permeable to one or more gases. As a result of the layers, the selectively permeable device may provide a durable dehydration system that may effectively dehydrate air or other desired gases or feed fluids. The composite, such as composite 110, may further comprise a crosslinking polymer, a cross-linker, and additives including but not limited to dispersants, surfactants, binders, alkali metal salts, alkaline earth metal salts, and solvents.

In some embodiments, the gas permeability of the membrane may be less than 1×10⁻⁵ L/m² s Pa. A suitable method for determining gas permeability can be ASTM D-727-58, TAPPI-T-536-88 standard method.

In some embodiments, the moisture permeability of the membrane may be greater than 500 g/m²·day or 1×10⁻⁵ g/m²·s·Pa. In some embodiments, the moisture permeability may be a measure of water vapor permeability/transfer rate at the above described levels. Suitable methods for determining moisture (water vapor) permeability are ASTM E96, ASTM D-6701 standard method.

In some embodiments, the selective permeability of the membrane may be reflected in a ratio of permeabilities of water vapor and at least one selected gas, e.g., oxygen and/or nitrogen, permeabilities. In some embodiments, the membrane may exhibit a water vapor permeability:gas permeability ratio, of greater than 50, greater than 100, greater than 200, greater than 400, greater than 1000, greater than 5000, greater than 10,000, greater than 15,000, or greater than 20,000. In some embodiments, the selective permeability may be a measure of water vapor:gas permeability/transfer rate ratios at the above described levels. Suitable methods for determining water vapor permeability and/or gas permeability have been disclosed above

In some embodiments, the selectively permeable element comprises a support and a composite coating the support material. In some embodiments, the membrane has a relatively high water vapor permeability. In some embodiments, the membrane may have a low gas permeability. In some embodiments, the support may be porous.

In some embodiments, the selectively permeable membrane may be disposed between or separate a fluidly communicated first fluid reservoir and a second fluid reservoir. In some embodiments, the first reservoir may contain a feed fluid upstream and/or at the selectively permeable element. In some embodiments, the first reservoir may contain a processed fluid downstream and/or at the selectively permeable element. In some embodiments, the selectively permeable element selectively passes undesired water vapor therethrough while retaining or reducing the passage of another gas or fluid material from passing therethrough. In some embodiments, the selectively permeable element may provide a filter element to selectively remove water vapor from a feed fluid while enabling the retention of processed fluid, substantially without the undesired water or water vapor described herein. In some embodiments, the selectively permeable element has a desired flow rate. In some embodiments, the selectively permeable element may comprise ultrafiltration material. In some embodiments, the selectively permeable element exhibits a flow rate of at least about 0.001 liters/min to about 0.1 liters/min; about 0.005 liters/min to about 0.075 liters/min; and/or about 0.01 liters/min to about 0.05 liters/min, for example at least about 0.005 liters/min, at least about 0.01 liters/minute, at least about 0.02 liters/min, at least about 0.05 liters/min, at least about 0.1 liters/min, at least about 0.5 liters/min and/or at least about 1.0 liters/min. In some embodiments, the selectively permeable element exhibits a flow rate of any combination of the previously described flow rates. In some embodiments, the selectively permeable element may comprise an ultrafiltration material. In some embodiments, the selectively permeable element comprises a filter characterized by a molecular weight cut off (MWCO) of at least 70%, 75%, 80%, 85%, 90%, 95%, 97% 99% of material having a molecular weight of 5000-200,000 Daltons. In some embodiments, the ultrafiltration material or a membrane comprising such material may have an average pore size or fluid passageways having an average diameter of between about 0.01 μm (10 nm) to about 0.1 μm (100 nm), and/or between about 0.01 μm (10 nm) to about 0.05 μm (50 nm). In some embodiments, the membrane surface area is between about 0.01 m², 0.05 m², 0.10 m², 0.25 m², 0.35 m², to about 0.50 m², 0.60 m², 0.70 m², 0.75 m², 1.00 m², 1.50 m² to about 2.50 m², or any combinations of the recited areas. In some embodiments, the membrane surface area is about at least 50 m².

### Porous Support

A porous support may be any suitable material and in any suitable form upon which a layer, such as a layer of the composite, may be deposited or disposed. In some embodiments, the porous support can comprise hollow fibers or porous material. In some embodiments, the porous support may comprise a porous material, such as a polymer or a hollow fiber. Some porous supports can comprise a non-woven fabric. In some embodiments, the polymer may be polyamide (Nylon), polyimide (PI), polyvinylidene fluoride (PVDF), polyethylene (PE), stretched PE, polypropylene (including stretched polypropylene), polyethylene terephthalate (PET), polysulfone (PSF), polyether sulfone (PES), cellulose, cellulose acetate, polyacrylonitrile (e.g. PA200), or a combination thereof. In some embodiments, the polymer can comprise PET. In some embodiments, the polymer comprises polypropylene. In some embodiments, the polymer comprises stretched polypropylene. In some embodiments, the polymer comprises polyethylene. In some embodiments, the polymer comprises stretched polyethylene.

### Composite

In some embodiments, the composite, e.g. composite 110, may coat the support. In some embodiments, the composite material comprises a graphene material and one or more polymers. Some embodiments include additional polymers and/or additives. In some embodiments, the graphene material and the polymer are covalently linked to one another. In some embodiments, the graphene material may be dispersed amongst the polymer material. In some embodiments, the selectively permeable membrane further comprises a cross-linker material.

In some embodiments, the graphene-containing composite further comprises an alkali metal halide or an alkaline earth metal halide. In some embodiments, the composite further comprises a surfactant, a binder, or a solvent.

The membranes of the current disclosure comprise a support and a composite comprising a graphene oxide compound and an ammonium salt polymer. In some embodiments the ammonium salt polymer can be poly(diallyldimethylammonium chloride) (polyDADMAC, polyDDA, PDADMA, and/or polyquaternium-6, see structure below).

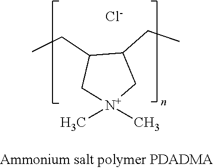

In some embodiments, the graphene material may be arranged in the polymer material in such a manner as to create an exfoliated nanocomposite, an intercalated nanocomposite, or a phase-separated microcomposite. A phase-separated microcomposite phase may be when, although mixed, the graphene material exists as separate and distinct phases apart from the polymer. An intercalated nanocomposite may be when the polymer compounds begin to intermingle amongst or between the graphene platelets but the graphene material may not be distributed throughout the polymer.

### Graphene Oxide

In general, graphene-based materials have many attractive properties, such as a 2-dimensional sheet-like structure with extraordinary high mechanical strength and nanometer scale thickness. Graphene oxide (GO), an exfoliated oxidation product of graphite, can be mass produced at low cost. With its high degree of oxidation, graphene oxide has high water permeability and also exhibits versatility to be functionalized by many functional groups, such as amines or alcohols, to form various membrane structures. Unlike traditional membranes, where the water is transported through the pores of the material, in graphene oxide membranes the transportation of water can be between the interlayer spaces. GO's capillary effect can result in long water slip lengths that offer a fast water transportation rate. Additionally, the membrane's selectivity and water flux can be controlled by adjusting the interlayer distance of graphene sheets, or by the utilization of different crosslinking moieties.

It is believed that there may be a large number (˜30%) of epoxy groups on GO, which may be readily reactive with hydroxyl groups at elevated temperatures. It is also believed that a GO sheet has an extraordinary high aspect ratio. This high aspect ratio may increase the available gas diffusion surface if dispersed in a polymeric membrane, e.g., an ammonium salt polymer membrane. Therefore, an ammonium salt polymer crosslinked by GO may not only reduce the water swelling of the membrane, but may also increase the membrane gas separation efficiency.

In some embodiments, the graphene oxide compound can be selected from graphene oxide, reduced-graphene oxide, functionalized graphene oxide, and functionalized reduced-graphene oxide. In some embodiments, the graphene can have a platelet size from: about 0.001 μm, 0.05 μm, 0.10 μm, 0.5 μm, or 1.0 μm, and up to: about 50 μm, about 100 μm, about 200 μm, and/or about 250 μm, about 0.001-10 μm, about 10-20 μm, about 20-30 μm, about 30-40 μm, about 40-50 μm, about 50-60 μm, about 60-70 μm, about 70-80 μm, about 80-90 μm, about 90-100 μm, about 100-110 μm, about 110-120 μm, about 120-130 μm, about 130-140 μm, about 140-150 μm, about 150-160 μm, about 160-170 μm, about 170-180 μm, about 180-190 μm, about 190-200 μm, about 200-210 μm, about 210-220 μm, about 220-230 μm, about 230-240 μm, about 240-250 μm, about 0.001-50 μm, about 50-100 μm, about 100-150 μm, about 150-200 μm, about 200-250 μm, about 0.001-100 μm, about 100-200 μm, about 100-250 μm, and/or any combination of these values.

Individual graphene platelets may be distributed within or throughout the polymer. An exfoliated nanocomposite phase may be achieved by chemically exfoliating the graphene material by a modified Hummer's method, a process well known to persons of ordinary skill. An exfoliated nanocomposite phase may be achieved by chemically exfoliating the graphene material by a modified Hummer's method, a process described in the Example below. It is believed that this methodology is useful in providing appropriately sized graphene oxide sheets for use in this currently described application. In some embodiments, the graphene oxide material can be sufficiently dispersed from one another with the polymer as the dominant or greater than majority material phase.

In some embodiments, the graphene material may be in the form of sheets, planes or flakes. In some embodiments, the graphene material may be in the form of platelets. In some embodiments, the graphene may have a platelet size of about 0.05 μm to about 300 μm. In some embodiments, the graphene may have a platelet size of about 75 μm to about 175 μm. In some embodiments, the graphene material may have a surface area of between about 1 m²/gm to about 5000 m²/g, 1-100 m²/g, 100-200 m²/g, 200-300 m²/g, 300-400 m²/g, 400-500 m²/g, 500-600 m²/g, 600-700 m²/g, 700-800 m²/g, 800-900 m²/g, 900-1,000 m²/g, 1,000-2,000 m²/g, 2,000-3,000 m²/g, 3,000-4,000 m²/g, or 4,000-5,000 m²/g. In some embodiments, the graphene material may have a surface area of about 150 m²/g to about 4000 m²/g. In some embodiments the graphene material may have a surface area of about 200 m²/g to about 1000 m²/g, e.g., about 400 m²/g to about 500 m²/g. It is believed that the graphene material component of the membrane provides a desired level of second gas impermeability to the membrane, e.g., the membrane can have a second gas permeability of less than 0.1 L/m² s Pa, less than 0.5 L/m² s Pa, or less than 1.0×10⁻⁵ L/m² s Pa.

In some embodiments, the graphene material may not be modified and may comprise a non-functionalized graphene base. In some embodiments, the graphene material may comprise a modified graphene. In some embodiments, the modified graphene may comprise a functionalized graphene. In some embodiments, at least about 10%, at least about 20%, at least about 30%, at least about 40%, at least about 50%, at least about 60%, at least about 70%, at least about 80%, or at least about 90%, of the graphene may be functionalized. In other embodiments, the majority of graphene material may be functionalized. In still other embodiments, substantially all the graphene material may be functionalized. In some embodiments, the functionalized graphene may comprise a graphene base and functional compound. A graphene may be “functionalized”, becoming functionalized graphene when there are one or more types of functional compounds are substituted instead of hydroxide in the carboxylic acid groups or one or more hydroxide locations in the graphene matrix. In some embodiments, the graphene base may be selected from graphene oxide, reduced graphene oxide, functionalized graphene oxide and/or functionalized and reduced graphene oxide.

The composite may contain any suitable amount of graphene oxide compound, such as about 0.01-20%, e.g. about 0.01-0.1%, about 0.1-0.2%, about 0.2-0.3%, about 0.3-0.4%, about 0.4-0.5%, about 0.5-0.6%, about 0.6-0.7%, about 0.7-0.8%, about 0.9-1%, about 1-1.1%, about 1.1-1.2%, about 1.2-1.3%, about 1.3-1.4%, about 1.4-1.5%, about 1.5-1.6%, about 1.6-1.7%, about 1.7-1.8%, about 1.8-1.9%, about 1.9-2%, about 0.0-1%, about 1-2%, about 2-3%, about 3-4%, about 4-5%, about 5-6%, about 6-7%, about 7-8%, about 8-9%, about 9-10%, about 10-11%, about 11-12%, about 12-13%, about 13-14%, about 14-15%, about 15-16%, about 16-17%, about 17-18%, about 18-19%, about 19-20%, about 0.01-3%, about 0.01-5%, about 5-10%, about 10-15%, about 15-20% of the total weight of the composite.

### Crosslinker

In some embodiments, the composite comprises a graphene oxide compound and a polymer. In some cases, the polymer is a crosslinking polymer. One possible crosslinking polymer is polyvinyl alcohol. In some embodiments, the weight ratio of graphene oxide to polyvinyl alcohol can be from about 0.1:100 to about 1:10. In some embodiments, an additional crosslinking element can be provided. In some embodiments, the additional crosslinking element can be potassium tetraborate (KBO) and sodium lignosulfate (LSU). In some embodiments, the composite can further comprise lithium chloride. In some embodiments, the composite can further comprise calcium chloride. In some embodiments, the composite can further comprise a surfactant. In some embodiments, the surfactant can be sodium lauryl sulfate.

The polyvinyl alcohol can be present in any suitable amount, such as about 1-80%, about 0.01-1%, about 1-2%, about 2-3%, about 3-4%, about 4-5%, about 5-6%, about 6-7%, about 7-8%, about 8-9%, about 9-10%, about 10-11%, about 11-12%, about 12-13%, about 13-14%, about 14-15%, about 15-16%, about 16-17%, about 17-18%, about 18-19%, about 19-20%, about 30-32%, about 32-34%, about 34-36%, about 36-38%, about 38-40%, about 40-42%, about 42-44%, about 44-46%, about 46-48%, about 48-50%, about 50-52%, about 52-54%, about 54-56%, about 56-58%, about 58-60%, about 60-62%, about 62-64%, about 64-66%, about 66-68%, about 68-70%, about 70-72%, about 72-74%, about 74-76%, about 76-78%, about 78-80%, about 0.1-10%, about 10-20%, about 20-30%, about 30-40%, about 40-50%, about 50-60%, about 60-70%, or about 70-80%, based upon the total weight of the composite.

In some embodiments, the polymer material may be a crosslinked polymer material, where the polymer may be crosslinked within the same polymer and/or with a different polymer by a cross linker material/bridge. In some embodiments, the polymer material may comprise crystalline polymer material and/or an amorphous polymer material. It is believed that the polymer crystals and chains that may be intercalated between the graphene material sheets may provide separation of the sheets, and/or mechanical and chemical barriers to intruding fluid and/or gases to substantially increase the permeation distance resulting in increased gas separation properties. In some embodiments, the polymer material can further comprise polyvinyl alcohol. It is thought that the polymer component of the membrane provides a desired level of water vapor permeability.

In some embodiments, the ammonium salt polymers can be

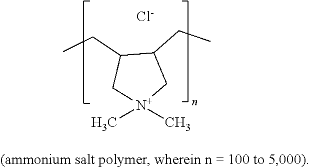

The ammonium salt polymer (e.g. PDADMA) can be present in any suitable amount, such as about 10-95%, about 20-22%, about 22-24%, about 24-26%, about 26-28%, about 28-30%, about 30-32%, about 32-34%, about 34-36%, about 36-38%, about 38-40%, about 40-42%, about 42-44%, about 44-46%, about 46-48%, about 48-50%, about 50-52%, about 52-54%, about 54-56%, about 56-58%, about 58-60%, about 60-62%, about 62-64%, about 64-66%, about 66-68%, about 68-70%, about 70-72%, about 72-74%, about 74-76%, about 76-78%, about 78-80%, about 80-82%, about 82-84%, about 84-86%, about 86-88%, about 88-90%, about 90-92%, about 92-94%, about 10-20%, about 20-30%, about 30-40%, about 40-50%, about 50-60%, about 60-70%, about 70-80%, about 80-90%, or about 90-95%, based upon the total weight of the composite.

In preparation for crosslinking, the graphene compound may be mixed with the polymer solution(s) (e.g. PVA and ammonium salt polymer) to form an aqueous mixture. In some embodiments the graphene is in an aqueous solution form. In some embodiments, the polymer comprises a polymer in an aqueous solution. In some embodiments, two solutions are mixed, the mixing ratio may be between about 0.1:100, about 1:10, about 1:4, about 1:2, about 1:1, about 2:1, about 4:1, about 9:1 and about 10:1 parts graphene compound solution to polymer solution. Some embodiments preferably use a mixing ratio of about 1:30. Some embodiments preferably use a mixing ratio of about 1:50. Some embodiments preferably use a mixing ratio of about 1:90.

In some embodiments, in addition to the two solutions (of the graphene compound and the polymer solution), a cross-linker solution is also added. In some embodiments, the mixing ratio may be between about 0.1:100, about 1:10, about 1:4, about 1:2, about 1:1, about 2:1, about 4:1, about 9:1 and about 10:1 parts graphene compound solution to cross-linker solution. Some embodiments preferably use a mixing ratio of about 1:10. Some embodiments preferably use a mixing ratio of about 1:50. Some embodiments preferably use a mixing ratio of about 1:70.

In some embodiments, the graphene compound and polymer solutions are mixed such that the dominant phase of the mixture comprises exfoliated nanocomposites. The reason for requiring the exfoliated-nanocomposites phase is that in this phase the graphene platelets are aligned such that permeability is reduced in the finished film by elongating the possible molecular pathways through the film. In some embodiments, the graphene compound may comprise any combination of the following: graphene, graphene oxide, and/or functionalized graphene oxide. In some embodiments, the graphene composition is suspended in an aqueous solution of between about 0.1 wt % and about 5 wt %, about 0.1-0.5 wt %, about 0.5-1 wt %, about 1-2 wt %, about 2-3 wt %, about 3-4 wt %, about 4-5 wt %, about 0.9 wt %, or about 0.8 wt % graphene oxide.

In some embodiments, the polymer material comprises an aqueous solution of about 1-5 wt %, about 5-10 wt %, about 10-15 wt %, about 15-20 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, about 75-80 wt %, about 80-85 wt %, about 85-90 wt %, about 90-95 wt %, or about 95-99% polymer.

In some embodiments, the graphene material and the polymer material may be crosslinked using a cross linker material. In some embodiments, the graphene material and the polymer material may be crosslinked by thermal reaction, and/or UV irradiation. In some embodiments, the graphene material and the polymer material may be crosslinked without an additional cross linker material by heating the materials to a sufficient temperature to thermally crosslink the materials. In some embodiments, e.g., when the polymer material may be polyvinyl alcohol, the graphene material and the polymer material may be crosslinked by applying between about 50° C. to about 125° C., for a period of between 5 minutes and 4 hours, e.g., 90° C. for about 30 minutes. In some embodiments, the graphene material and the polymer material may be crosslinked without an additional cross linker material by sufficient exposure to ultraviolet radiation.

In some embodiments, the same types of cross linker materials are used to crosslink the graphene material, the polymer material or both the graphene and polymer material, e.g., the same type of cross linker materials may covalently link the graphene material and the polymer material; and/or the polymer material with itself or other polymer materials. In some embodiments, the same cross linker material is used to crosslink the graphene material as well as the polymer material.

### Additives

An additive or an additive mixture may, in some instances, improve the performance of the composite. Some crosslinked GO-based composites can also comprise an additive mixture. In some embodiments, the selectively permeable element may comprise a dispersant. In some embodiments, the dispersant may be ammonium salts, e.g., NH₄Cl; Flowlen; fish oil; long chain polymers; stearic acid; oxidized Menhaden Fish Oil (MFO); dicarboxylic acids such as but not limited to succinic acid, ethanedioic acid, propanedioic acid, pentanedioic acid, hexanedioic acid, heptanedioic acid, octanedioic acid, nonanedioic acid, decanedioic acid, o-phthalic acid, and p-phthalic acid; sorbitan monooleate; and mixtures thereof. Some embodiments preferably use oxidized MFO as a dispersant.

In some embodiments, the selectively permeable element may comprise a surfactant. In some embodiments, the surfactant can be sodium lignosulfate (LSU). In some embodiments, the surfactant can be sodium lauryl sulfate (SLS). In some embodiments, LSU can be present in the selectively permeable element in an amount between about 1-5 wt %, about 1-2 wt %, about 2-3 wt %, about 3-4 wt %, about 4-5 wt %, or about 2 wt %. In some embodiments, SLS can be present in the selectively permeable element in an amount between about 1-5 wt %, about 1-2 wt %, about 2-3 wt %, about 3-4 wt %, about 4-5 wt %, or about 2 wt %.

In some embodiments, the selectively permeable element may further comprise a binder. In some embodiments, the binder may be lignin analogues. In some embodiments, the lignin analogues can comprise sodium lignosulfate. In some embodiments, the binder may be analogues. In some embodiments, the binder may be, e.g., potassium tetraborate (K₂B₄O₇) analogues.

In some embodiments, the composite of the selectively permeable element may further comprise an alkali metal halide. In some embodiments, the alkali metal can be lithium. In some embodiments, the halide can be chloride. In some embodiments, the alkali metal halide salt can be LiCl. In some embodiments the alkali halide can be present in the selectively permeable element in an amount between about 1-5 wt %, about 5-10 wt %, about 10-15 wt %, about 15-20 wt %, about 20-25 wt %, about 25-30 wt %, about 30-35 wt %, about 35-40 wt %, about 40-45 wt %, about 45-50 wt %, about 30 wt %, or about 20 wt %.

In some embodiments, the composite of the selectively permeable element may further comprise an alkaline earth metal halide. In some embodiments, the alkaline earth metal can be calcium. In some embodiments, the halide can be chloride. In some embodiments, the alkaline earth metal halide salt can be CaCl₂. In some embodiments the alkaline earth halide can be present in the selectively permeable element in an amount between about 1-5 wt %, about 5-10 wt %, about 10-15 wt %, about 15-20 wt %, about 20-25 wt %, about 25-30 wt %, about 30-35 wt %, about 35-40 wt %, about 40-45 wt %, about 45-50 wt %, about 30 wt %, or about 20 wt %.

In some embodiments, solvents may also be present in the selectively permeable element. Used in manufacture of material layers, solvents include, but are not limited to, water, a lower alkanol such as but not limited to ethanol, methanol, isopropyl alcohol, xylenes, cyclohexanone, acetone, toluene and methyl ethyl ketone, and mixtures thereof.

### Protective Coating

Some membranes may further comprise a protective coating. For example, the protective coating can be disposed on top of the membrane to protect it from the environment. The protective coating may have any composition suitable for protecting a membrane from the environment, Many polymers are suitable for use in a protective coating such as one or a mixture of hydrophilic polymers, e.g. polyvinyl alcohol (PVA), polyvinyl pyrrolidone (PVP), polyethylene glycol (PEG), polyethylene oxide (PEO), polyoxyethylene (POE), polyacrylic acid (PAA), polymethacrylic acid (PMMA) and polyacrylamide (PAM), polyethylenimine (PEI), poly(2-oxazoline), polyethersulfone (PES), methyl cellulose (MC), chitosan, poly (allylamine hydrochloride) (PAH), poly (sodium 4-styrene sulfonate) (PSS), and any combinations thereof. In some embodiments, the protective coating can comprise PVA. In some embodiments, the protective coating is a polymer comprised of trimesoyl chloride and meta-phenylenediamine.

### Methods of Making Dehydration Membranes

In some embodiments, a method for creating the aforementioned selectively permeable element is provided. Some embodiments include methods for making a dehydration membrane comprising: (a) mixing the graphene oxide material, a polymer such as PDADMA, and an additive in an aqueous mixture to generate a composite coating mixture; (b) applying the coating mixture on a porous support to form a coated support; (c) repeating step (b) as necessary to achieve the desired thickness of coating; and (d) curing the coating at a temperature of about 60-120° C. for about 30 seconds to about 3 hours to facilitate crosslinking within the coated mixture. In some embodiments, the method comprises pre-treating the porous support. In some embodiments, the method further comprises coating the assembly with a protective layer. An example of a possible method embodiment of making an aforementioned membrane is shown in FIG. 2.

In some embodiments, the porous support can be pre-treated to aid in the adhesion of the composite layer to the porous support. In some embodiments, the porous support can be modified to become more hydrophilic. For example, the modification can comprise a corona treatment using 70 W power with 2-4 counts at a speed of 0.5 m/min.

In some embodiments, the mixture may be blade coated on a permeable or non-permeable support to create a thin film between about 1 μm to about 30 μm, e.g., may then cast on a support to form a partial element. In some embodiments, the mixture may be disposed upon the support spray coating, dip coating, spin coating and/or other methods for deposition of the mixture on a substrate known to those skilled in the art. In some embodiments, the casting may be done by co-extrusion, film deposition, blade coating or any other method for deposition of a film on a substrate known to those skilled in the art. In some embodiments, the mixture is cast onto a substrate by blade coating (or tape casting) by using a doctor blade and dried to form a partial element. The thickness of the resulting cast tape may be adjusted by changing the gap between the doctor blade and the moving substrate. In some embodiments, the gap between the doctor blade and the moving substrate is in the range of about 0.002 mm to about 1.0 mm. In some embodiments, the gap between the doctor blade and the moving substrate is preferably between about 0.20 mm to about 0.50 mm. Meanwhile, the speed of the moving substrate may have a rate in the range of about 30 cm/min. to about 600 cm/min. By adjusting the moving substrate speed and the gap between the blade and moving substrate, the thickness of the resulting graphene polymer layer may be expected to be between about 1 μm and about 200 μm. In some embodiments, the thickness of the layer may be about 10 μm such that transparency is maintained. In some embodiments, the coating is done such that a composite layer of a desired thickness is created. In some embodiments, the number of layers can range from 1-250, from about 1-100, from 1-50, from 1-20, from 1-15, from 1-10, or 1-5. This process results in a fully coated substrate, or a coated support that is a selectively permeable element. In some embodiments, the total thickness of the membrane described herein can be between about 1 μm and about 200 μm. It is believed that the overall thickness of the membrane can contribute to high thermal conductivity for effective heat transfer.

In some embodiments, the porous support is coated at a coating speed that is 0.5-15 meter/min, about 0.5-5 meter/min, about 5-10 meter/min, or about 10-15 meter/min. These coating speeds are particularly suitable for forming a coating layer having a thickness of about 1-3 μm, about 1 μm, about 1-2 μm, or about 2-3 μm. In some embodiments, the composite has a thickness of about 0.01-1 μm, about 1-2 μm, about 2-3 μm, about 3-4 μm, about 4-5 μm, about 5-6 μm, about 6-7 μm, about 7-8 μm, about 8-9 μm, or about 9-10 μm.

In some embodiments, after deposition of the graphene layer on the substrate, the selectively permeable element may then be dried to remove the underlying solution from the graphene layer. In some embodiments, the drying temperature may be about at room temperature, or 20° C., to about 120° C. In some embodiments the drying time may range from about 15 minutes to about 72 hours depending on the temperature. The purpose is to remove any water and precipitate the cast form. Some embodiments prefer that drying is accomplished at temperatures of about 90° C. for about 30 minutes.

In some embodiments, the method comprises drying the mixture for about 15 minutes to about 72 hours at a temperature ranging between from about 20° C. to about 120° C. In some embodiments, the dried selectively permeable element may be isothermally crystallized, and/or annealed. In some embodiments, annealing may be done from about 10 hours to about 72 hours at an annealing temperature of about 40° C. to about 200° C. Some embodiments prefer that annealing is accomplished at temperatures of about 100° C. for about 18 hours. Other embodiments prefer annealing done for 16 hours at 100° C.

In some embodiments, the selectively permeable element can further comprise a protective coating layer, such that the graphene layer is sandwiched between the substrate and the protective layer. The method for adding layers may be by co-extrusion, film deposition, blade coating or any other method known by those skilled in the art. In some embodiments, additional layers may be added to enhance the properties of the selectively permeable. In some embodiments, the protective layer is secured to the graphene with an adhesive layer to the selectively permeable element to yield the selectively permeable device. In other embodiments, the selectively permeable element is directly bonded to the substrate to yield the selectively permeable device.

### Methods for Reducing Water Vapor Content of a Gas Mixture

A selectively permeable membrane, such as the dehydration membranes described herein, may be used in methods for removing water vapor or reducing water vapor content from an unprocessed gas mixture, such as air, containing water vapor, for applications where dry gases or gases with low water vapor content are desired. The method comprises passing a first gas mixture (an unprocessed gas mixture), such as air, containing water vapor through the membrane, whereby the water vapor is allowed to pass through and removed, while other gases in the gas mixture, such as air, are retained to generate a second gas mixture (a dehydrated gas mixture) with reduced water vapor content. The embodiments disclosed herein may be provided as part of a module into which water vapor (saturated or near saturated) and compressed air are introduced. The module produces a dry pressurized product stream and a low pressure permeate stream. The permeate stream may contain a mixture of air and the bulk of the water vapor introduced into the module.

In some embodiments, the membrane has a water vapor permeability of at least 0.5×10⁻⁵ g/m²·s·Pa, at least 1.0×10⁻⁵ g/m²·s·Pa, at least 1.5×10⁻⁵ g/m²·s·Pa, at least 2.0×10⁻⁵ g/m²·s·Pa, at least 2.5×10⁻⁵ g/m²·s·Pa, at least 3.0×10⁻⁵ g/m²·s·Pa, at least 3.5×10⁻⁵ g/m²·s·Pa, at least 4.0×10⁻⁵ g/m²·s·Pa, at least 4.5×10⁻⁵ g/m²·s·Pa, at least 5.0×10⁻⁵ g/m²·s·Pa, at least 5.5×10⁻⁵ g/m²·s·Pa, or at least 6.0×10⁻⁵ g/m²·s·Pa. In some embodiments, applying the membrane includes selectively passing water vapor therethrough. In some embodiments, the membrane is impermeable or relatively impermeable to the gas component.

In some embodiments, the membrane has a gas permeability of less than 1×10⁻⁵ LI m²·s·Pa, less than 5×10⁻⁶ L/m²·s·Pa, less than 1×10⁻⁶ L/m²·s·Pa, less than 5×10⁻⁷ L/m²·s·Pa, less than 1×10⁻⁷ L/m²·s·Pa, less than 5×10⁻⁸ L/m²·s·Pa, less than 1×10⁻⁸ L/m²·s·Pa, less than 5×10⁻⁹ L/m²·s·Pa, less than 1×10⁻⁹ L/m²·s·Pa, less than 5×10⁻¹° L/m²·s·Pa, or less than 1×10⁻¹⁰ L/m²·s·Pa. In some embodiments, the gas component can comprise air, hydrogen, carbon dioxide, and/or a short chain hydrocarbon. In some embodiments the short chain hydrocarbon can be methane, ethane or propane.

Permeated air or a secondary dry sweep stream may be used to optimize the dehydration process. If the membrane were totally efficient in water separation, all the water or water vapor in the feed stream would be removed, and there would be nothing to sweep it out of the system. As the process proceeds, the partial pressure of the water on the feed or bore side becomes lower and lower, and the pressure on the shell-side becomes higher. This pressure difference tends to prevent additional water from being expelled from the module. Since the object is to make the bore side dry, the pressure difference interferes with the desired operation of the device. A sweep stream may therefore be used to remove the water or water vapor from the shell side, in part by absorbing some of the water, and in part by physically pushing the water out.

If a sweep stream is used, it may comprise an external dry source or a partial recycle of the product stream of the module. In general, the degree of dehumidification will depend on the partial pressure ratio of water vapor across the membrane and on the product recovery (the ratio of product flow to feed flow). Better membranes have a high product recovery at low levels of product humidity and/or higher volumetric product flow rates.

A dehydration membrane may be used to remove water for energy recovery ventilation (ERV). ERV is the energy recovery process of exchanging the energy contained in normally exhausted building or space air and using it to treat (precondition) the incoming outdoor ventilation air in residential and commercial HVAC systems. During the warmer seasons, an ERV system pre-cools and dehumidifies while humidifying and pre-heating in the cooler seasons.

The membranes of the present disclosure are easily made at low cost, and may outperform existing commercial membranes in either volumetric productivity or product recovery.

The following embodiments are contemplated.

### Embodiment 1

A dehydration membrane comprising:

a support;

a composite comprising a graphene oxide compound and an ammonium salt polymer;

wherein the composite coats the support; and

wherein the membrane has a high moisture permeability and low gas permeability.

### Embodiment 2

The membrane of Embodiment 1, wherein the ammonium salt polymer is a poly(diallyldimethylammonium) salt.

### Embodiment 3

The membrane of Embodiment 1, wherein the support is porous.

### Embodiment 4

The membrane of Embodiment 1, wherein the support comprises polypropylene, polyethylene terephthalate, polysulfone, or polyether sulfone.

### Embodiment 5

The membrane of Embodiment 1, further comprising polyvinyl alcohol.

### Embodiment 6

The membrane of Embodiment 5, wherein the graphene oxide and polyvinyl alcohol are crosslinked.

### Embodiment 7

The membrane of Embodiment 5, where the weight ratio of graphene oxide to polyvinyl alcohol is from about 0.1:100 to about 9:1.

### Embodiment 8

The membrane of Embodiment 1, wherein the graphene oxide compound is selected from graphene oxide, reduced-graphene oxide, functionalized graphene oxide, and functionalized reduced-graphene oxide.

### Embodiment 9

The membrane of Embodiment 1, wherein the graphene has a platelet size from about 0.05 μm to about 100 μm.

### Embodiment 10

The membrane of Embodiment 1, where the membrane comprises hollow fibers.

### Embodiment 11

The membrane of Embodiment 1, wherein the composite further comprises calcium chloride.

### Embodiment 12

The membrane of Embodiment 1, wherein the composite further comprises a surfactant.

### Embodiment 13

The membrane of Embodiment 12, wherein the surfactant is sodium lauryl sulfate.

### Embodiment 14

A method for treating a gas comprising:

providing a membrane of Embodiments 1-13;

applying the membrane to a complex mixture having a first gas component comprising water vapor, removing the water vapor from the first gas to generate a second gas component.

### Examples

It has been discovered that embodiments of the selectively permeable elements described herein have improved permeability resistance to both oxygen gas and vapor with acceptable material properties as compared to other selectively permeable elements. These benefits are further shown by the following examples, which are intended to be illustrative of the embodiments of the disclosure, but are not intended to limit the scope or underlying principles in anyway.

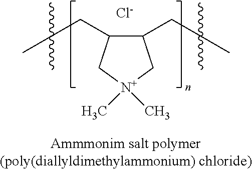

Poly(diallyldimethylammonium) chloride was purchased from Sigma-Aldrich (St. Louis, Mo., USA) and used without additional purification. A 5 wt % solution was prepared with deionized water (DI).

### Membrane Coating Procedure

### Coating Solution Preparation:

GO was prepared from graphite using modified Hummers method. Graphite flake (4.0 g, Aldrich, 100 mesh) was oxidized in a mixture of NaNO₃ (4.0 g), KMnO₄ (24 g) and concentrated 98% H₂SO₄ (192 mL) at 50° C. for 15 hours; then the resulting pasty mixture was poured into ice (800 g) following by the addition of 30% hydrogen peroxide (40 mL). The resulting suspension was stirred for 2 hours to reduce manganese dioxide, then filtered through filter paper and the solid washed with 500 mL of 0.16 M HCl aqueous solution then DI water twice. The solid was collected and dispersed in DI water (2 L) by stirring for two days, then sonicated with 10 W probe sonicator for 2 hours with ice-water bath cooling. The resulting dispersion was centrifuged at 3000 rpm for 40 min to remove large non-exfoliated graphite oxide. Sufficient DI water was added to prepare a 0.1 wt % aqueous GO dispersion.

Combine the 1 mL GO (0.1%) with 4.4 mL water and sonicate it for about 3 minutes. After GO is completely dispersed in the water, added 1 mL of poly(diallyldimethylammonium chloride) (PDADMA, 5.0 wt % aqueous solution) and 2 mL of PVA (2.5% in water) in the solution. Then sonicate the solution about 8 minutes. After observing that the PDADMA and PVA is completely dissolved in the water solution, 0.4 mL of CaCl₂ (5%) (Sigma Aldrich, St. Louis, Mo., USA) is added and the solution is sonicated about 6 minutes to completely dissolve CaCl₂) in the solution.

As shown in Table 1 below EX-1 to Ex-3 were made in a manner similar to Ex-4, except for, e.g., (a) different weight ratios of PVA and PDADMA were utilized, and (b) optionally materials, e.g., SLS, CaCl₂ were used in amounts/ratios described.

Substrate treatment: Porous polypropylene substrate (Celgard 2500) was modified by corona treatment using power of 70 W, 3 counts, speed of 0.5 m/min.

### Coating and Curing:

The coating solution was applied on the freshly treated substrate, with 200 μm wet gap. The resulting membrane was dried then cured at 110° C. for 5 min. During curing the GO and PVA was crosslinked.

### Measurement of Selectively Permeable Elements

Ex-1, Ex-2, Ex-3, and Ex-4 made as described above were tested for Nitrogen permeance as described in ASTM 6701, at 23° C. and 0% relative humidity (RH). The results are shown in Table 1.

Ex-1, Ex-2, Ex-3, and Ex-4 made as described above were tested for water vapor transmission rate (WVTR) as described in ASTM E96 standard method, at 20° C. and 100% relative humidity (RH). The results are shown in Table 1.

TABLE 1
Water vapor permeance and H₂O/N₂ selectivity of GO-PVA-PDADMA membranes

| | | | | Water | |
|---|---|---|---|---|---|
| | | | | vapor | N₂ |
| | | | | Permeance | Permeance |
| Composition | Ratio (wt/wt) | Thickness | Substrate | (g/m² s Pa) | (L/m² s Pa) |
| EX-1 | 1/10/90/2 | 3 μm | Poly- | 6.2 × 10⁻⁵ | 4 × 10⁻⁹ |
| [GO/PVA/PDADMA/SLS] | | | propylene | | |
| EX-2 | 1/70/30/2 | 3 μm | Poly- | 3.0 × 10⁻⁵ | |
| [GO/PVA/PDADMA/SLS] | | | propylene | | |
| EX-3 | 1/50/50/2 | 3 μm | Poly- | 3.3 × 10⁻⁵ | |
| [GO/PVA/PDADMA/SLS] | | | propylene | | |
| EX-4 | 1/50/50/2/20 | 3 μm | Poly- | 4.0 × 10⁻⁵ | |
| [GO/PVA/PDADMA/SLS/CaCl₂] | | | propylene | | |

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the current disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illuminate the current disclosure and does not pose a limitation on the scope of any claim. No language in the specification should be construed as indicating any non-claimed element essential to the practice of the current disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the current disclosure. Of course, variations on these described embodiments will become apparent to those of ordinary skill in the art upon reading the foregoing description. The inventor expects skilled artisans to employ such variations as appropriate, and the inventors intend for the current disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A membrane for the dehydration of a gas, comprising:
a porous support;
a composite comprising a graphene oxide compound and an ammonium salt polymer;
wherein the composite is coated on the porous support; and
wherein the membrane has high moisture permeability and low gas permeability.

2. The membrane of claim 1, wherein the membrane has a moisture permeability of greater than 1×10⁻⁵ g/m²·s·Pa and gas permeability of less than 1×10⁻⁸ L/m²·s·Pa.

3. The membrane of claim 1, wherein the ammonium salt polymer is a poly(diallyldimethylammonium) salt.

4. The membrane of claim 1, wherein the ammonium salt polymer is poly(diallyldimethylammonium) chloride.

5. The membrane of claim 1, wherein the porous support comprises polypropylene, polyethylene terephthalate, polysulfone, or polyether sulfone.

6. The membrane of claim 1, further comprising polyvinyl alcohol.

7. The membrane of claim 6, wherein the graphene oxide compound and the polyvinyl alcohol are crosslinked.

8. The membrane of claim 6, wherein the weight ratio of the graphene oxide compound to polyvinyl alcohol is from about 0.1:100 to about 9:1.

9. The membrane of claim 1, wherein the graphene oxide compound comprises graphene oxide, reduced graphene oxide, functionalized graphene oxide, or functionalized and reduced graphene oxide.

10. The membrane of claim 1, wherein the graphene oxide compound has a platelet size from about 0.05 μm to about 100 μm.

11. The membrane of claim 1, further comprising an alkaline earth metal.

12. The membrane of claim 11, wherein the alkaline earth metal comprises calcium chloride.

13. The membrane of claim 1, further comprising a surfactant.

14. The membrane of claim 13, wherein the surfactant is sodium lauryl sulfate.

15. The membrane of claim 1, wherein the composite is a layer that has a thickness of about 1 μm to about 200 μm.

16. The membrane of claim 1, further comprising a protective layer.

17. A method of dehydrating a gas, comprising:
introducing a first gas containing water vapor to a first side of the membrane of claim 1;
wherein the water vapor pressure on the first side of the membrane is higher than the water vapor pressure on the second side of the membrane and water vapor from the first gas passes through the membrane from the first side to the second side;
wherein the retained gas is retained on the first side of the membrane to generate a second gas;
wherein the second gas has a lower water vapor pressure than the first gas.

18. The method of claim 17, further comprising a sweep gas on the second side of the membrane that removes water vapor.

19. A method for making a membrane for the dehydration of a gas, comprising
annealing and drying a coating on a treated support;
wherein the support is corona treated;
wherein the coating is a mixture comprising 1) graphene oxide, and 2) PVA, PDADMA, SLS, CaCl₂, or any combination thereof; and
optionally adding a protective layer.
